(19) United States
(12) Patent Application Publication
(10) Pub. No.: US 2007/0214487 A1
(43) Pub. Date: Sep. 13, 2007

(54) Video transmission device and method thereof

(76) Inventor: S. T. Joung, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/400,262

(22) Filed: Apr. 10, 2006

(30) Foreign Application Priority Data
Mar. 7, 2006 (TW) 95107643

(51) Int. Cl. H04N 7/173; H04N 7/16

(52) U.S. Cl. 725/116; 725/100; 725/131; 725/151; 725/114; 725/144; 725/146

(57) ABSTRACT

A video transmission device and method thereof, which assembles required components and installs an input/output card in a portable device to form a light and handy video transmission device instead of a heavy and clumsy transmission medium in order to transmit data signals to a display device.

### BACKGROUND OF THE INVENTION

1. Field of the Invention

The present invention relates to a peripheral device, and more particularly to a video transmission device and method thereof.

2. Description of the Prior Art

The digital electronic products have rapidly developed since the first calculator was invented in the whole world. However, it is not to satisfy the requirements of the different users even if the development of the computer technology that it is from the calculator to the personal computer, and further the personal computer to the super computer. Although the developments of the personal computers have gradually matured and the functionalities of the personal computers have satisfied users' requirements, it is not convenient and difficult to move due to the heavy volume and clumsy weight. Hence, some portable digital electronic products have sequentially invented, such as the notebook computers, personal digital assistants (PDA) and smart phones.

When these portable devices need to output data or display data, they need to combine the transmission medium such as desktop computers, note book computers etc. so that the data are transmitted to the desktop computer or note book computer and next are transmitted to the display device is connected to the desktop computer or note book computer for displaying, such as the projector, computer monitor, video monitor etc. However, if the users don't take transmission media such as a personal computer or a notebook computer along or take place a malfunction of the transmission media, the data aren't outputted and displayed by the transmission media and the display devices.

In addition, the transmission media such as the personal computers or notebook computers are heavy and clumsy so that it is difficult that the users take them with themselves.

The inventor of the present invention recognizes the above shortage should be corrected and special effort has been paid to research this field. The present invention is presented with reasonable design and good effect to resolve the above problems.

### SUMMARY OF THE INVENTION

It is a primary object of the present invention to provide a video transmission device instead of a heavy and clumsy transmission medium in order to transmit data signals to a display device.

For achieving the primary objective stated above, a video transmission device of the present invention comprises an input/output card, a receiver-transmitter unit, a processing unit, a memory unit and a terminal output unit.

When the data signals of the portable device need to be outputted, the receiver-transmitter unit receives the data signals by the input/output card and transmits the data signals received to the processing unit, and the processing unit processes the data signals and transmits the data signals processed to the terminal output end for outputting.

According to the video transmission device and method thereof, the receiver-transmitter unit of the video transmission device further comprises a receiving channel to receive a control signal from a remote controller so as to assist an operation of the video transmission device and increase a functionality of the video transmission device.

According to the video transmission device and method thereof, the memory unit of the video transmission device further comprises an extension slot interface so that an external memory can be installed in the video transmission device and transmits the data signals to the terminal output unit for outputting.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The above and further advantages of this invention may be better understood by referring to the following description, taken in conjunction with the accompanying drawings, in which:

FIG. 1 is a system block diagram of a video transmission device of the present invention; and

FIG. 2 is a flowchart of the video transmission device for transmitting data signals of the present invention.

The drawings will be described further in connection with the following detailed description of the present invention.

### DETAILED DESCRIPTION OF THE PREFERRED EMBODIMENTS

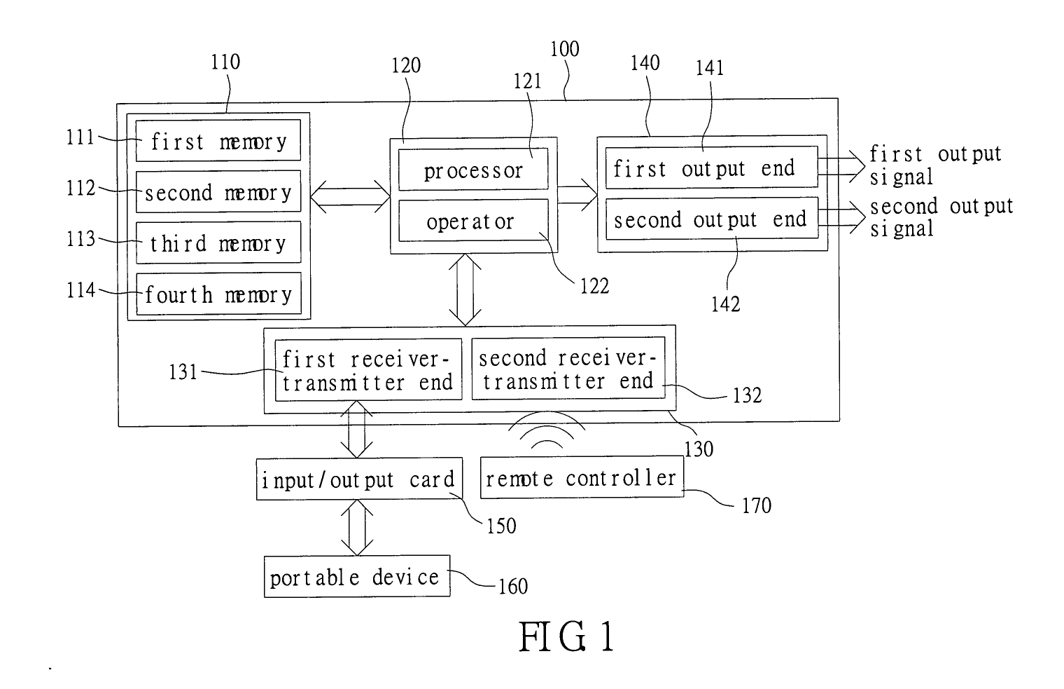

Reference is made to FIG. 1 which is a system block diagram of a video transmission device of the present invention. A video transmission system comprises a video transmission device 100, a portable device 160 and a remote controller 170. The video transmission device 100 comprises a memory unit 110, a processing unit 120, a receiver-transmitter unit 130, a terminal output unit 140 and an input/output card 150.

The portable device 160 is used to input data signals to the video transmission device 100 and further display the data signals inputted, so the portable device 160 can be a personal digital assistant (PDA) or a portable phone.

The remote controller 170 is used to input a control signal to the video transmission device 100 by transmitting infrared rays so as to assist an operation of the video transmission device 100.

The memory unit 110 comprises a first memory 111, a second memory 112, a third memory 113 and a fourth memory 114. The first memory 111 is used to store system data such as programs, commands and so on for the processing unit 120, so the first memory 111 can be a flash memory. The second memory 112 is used to store operation messages operated by the processing unit 120, so the second memory 112 can be a frame memory. The third memory 113 is used to temporarily store operation messages that are produced while the processing unit 120 processes the data signals, so the third memory 113 can be a synchronous dynamic random access memory (SDRAM). The fourth memory 114 is installed in the video transmission device 100 by an extension slot interface (not shown) for transmitting the data signals stored in the fourth memory 114 to the terminal output unit 140 for outputting, so the fourth memory 114 can be an external memory.

The processing unit 120 is connected with the memory unit 110, the receiver-transmitter unit 130 and the terminal output unit 140, and comprises a processor 121 and an operator 122. The processor 121 creates a data path for controlling an inside operation of the video transmission device 100 by the system data of the first memory 111 so as to receive the data signals inputted by the receiver-transmitter unit 130 and transmit the data signals to the operator 122 for a data operation; during the operation of the processing unit 120, the operation messages are stored in the third memory 113 and either stored in the second memory 112, so the operator 122 can be a digital signal processing chip (DSP chip) and the processing unit 120 can be a DSP digital image engine.

The receiver-transmitter unit 130 comprises a first receiver-transmitter end 131 and a second receiver-transmitter end 132. The first receiver-transmitter end 131 is used to receive the data signals inputted by the portable device 160, so the first receiver-transmitter end 131 can be a secure digital input/output end.

The second receiver-transmitter end 132 is used to provide a receiving channel to receive the control signal from the remote controller 170 and transmit the control signal to the processing unit 120 and further assists an operation of the video transmission device 100 and increases a functionality of the video transmission device 100, so the second receiver-transmitter end 132 can be an infrared remote control interface.

The terminal output unit 140 comprises a first output end 141 and a second output end 142. The first output end 141 is used to encode the data signals inputted by the processing unit 120 and outputs the encoded data signals to a display device, so the first output end 141 can be an encoder. The second output end 142 is used to reassemble the data signals inputted by the processing unit 120 and transmit the data signals reassemble to a display device (not shown), so the second output end 142 can be a de-interlacer. Here, the display device can be a TV monitor, projector or a computer monitor.

The input/output card 150 is connected with the first receiver-transmitter end 131 of the video transmission device 100 by a cable and installed in a slot of the portable device 160. Moreover, the portable device 160 sends the data signals that stored in the portable device 160 to the first receiver-transmitter end 131 through the input/output card 150, so the input/output card 150 can be a secure digital input/output card.

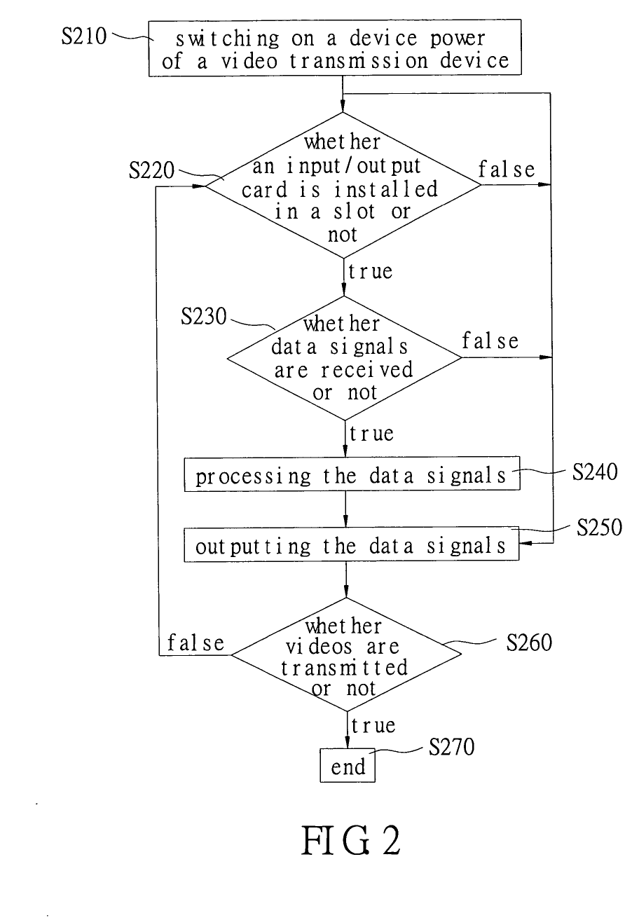

The above embodiment is described in FIG. 2. At step S210, a device power of the video transmission device 100 is switched on, the display device connected with the video transmission device 100 shows a status signal of the video transmission device 100. At step S220, the processing unit 120 starts to detect whether the input/output card 150 is installed in the portable device 160 or not according to the system data stored in the first memory 111. If the processing unit 120 detects which the input/output card 150 has not been installed in the portable device 160, the video transmission device 100 will output an un-installed status signal (the un-installed status signal means no input/output card 150 in the portable device 160) to the display device and continue to detect whether the input/output card 150 is installed in the portable device 160 or not; if the processing unit 120 detects that the input/output card 150 has been installed in the portable device 160, the display device will show an installed status signal (the installed status signal means that there is a input/output card 150 in the portable device 160) and proceeds to next step. At step S230, the processing unit 120 further detects whether there is at least one data signal that is required to be sent to the video transmission device 100 or not. If the processing unit 120 detects no data signal, the processing unit 120 outputs an un-received status signal (the un-received status signal means that there is no data signal) to the display device and continues to detect whether there is at least one data signal in the portable device 160; if the processing unit 120 detects that there is at least one data signal, the transmission device 100 further receives the data signal from the portable device 160 based on the input/output card 150 connected with the first receiver-transmitter end 131 for next step, and display device shows a received status signal (the status signal means that the transmission device 100 has to receive the data signal). At step S240, the processing unit 120 processes the data signal according to the system data stored in the first memory 111, and the operation messages produced by the processing unit 120 are temporarily stored in the third memory 113 and either stored in the second memory 112. At step S250, the terminal output unit 140 outputs the data signals that are processed by the processing unit 120. If the video transmission device 100 is connected to the display device (not shown), the terminal output unit 140 will send the data signal and a display status signal (the display status signal means the display device will show the data signal) to the display device. At Step S260, the processing unit 120 continuously detects whether the portable device 160 still has any data signal standby showed on display device. If the processing unit 120 detects at least one data signal standby, the process will return to step S220 and continue the stated above operations. If the processing unit 120 detects no data signal standby, the video transmission device 100 will stop all of the above process such as receiving any data signal, processing data signals and outputting data signals at step S270. During the process of transmitting data signals, the remote controller 170 can input a control signal to assist the operation of the video transmission device 100 so as to provide more services of processing the data signals.

Besides the portable device 160, the video transmission device 100 can receive the data signal from the external fourth memory 114 through the extension slot interface and further operate all of the above process.

Further speaking, if the video transmission device 100 is connected to a TV monitor or a projector, according to the system data stored in the first memory 111, the processing unit 120 will transmit the processed data signal to the first output end 141 of the terminal output unit 140. The terminal output unit 140 will encode the data signal as a first output signal and send the first output signal to the TV monitor or the projector. Here, the first output signal can be a video signal or an S-video signal.

On the other way, if the video transmission device 100 is connected to a computer monitor or the projector, according to the system data stored in the first memory 111, the processing unit 120 will transmit the data signals to the second output end 142 of the terminal output unit 140. The terminal output unit 140 will interlace the data signal as a second output signal, and send the second output signal to the computer monitor or the projector. Here, the second output signal can be a VGA output signal.

In addition, the first receiver-transmitter end 131 of the receiver-transmitter unit 130 has a compatibility of one bit and four bits to provide the portable device 160 for inputting the data signals.

The video transmission device of the present invention has the following advantages:

1. It is to assemble required components and install an input/output card in a portable device so as to form a light and handy video transmission device;

2. A remote controller is used to assist the video transmission device and increase a functionality of the video transmission device;

3. The data signals can be transmitted to the display device by the video transmission device, even if the users don't take transmission media such as a personal computer or a notebook computer along or take place a malfunction of the transmission media;

4. The video transmission device is smaller and lighter so it is to greatly increase a convenience for operating;

5. The video transmission device provides a receiving channel to receive the control signal inputted by the remote controller and further assists an operation of the video transmission device and increases a functionality of the video transmission device; and

6. The fourth memory is installed in the video transmission device by an extension slot interface for transmitting the data signals in the fourth memory to the terminal output unit for outputting.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A video transmission device, comprising:
an input/output card;
a receiver-transmitter unit for transmitting and receiving a data signal by the input/output card, and receiving a control signal from a remote controller;
a processing unit connected with the receiver-transmitter unit for processing the data signal inputted by the receiver-transmitter unit, and providing a data path for further executing a control action;
a memory unit connected with the processing unit for storing an operation message of the data signal processed by the processing unit and a system data for the processing unit processing the data signal; and
a terminal output unit connected with the processing unit for processing and outputting the data signal inputted by the processing unit.

2. The video transmission device as in claim 1, wherein the input/output card is a secure input/output card.

3. The video transmission device as in claim 1, wherein the receiver-transmitter unit comprises a first receiver-transmitter end and a second receiver-transmitter end.

4. The video transmission device as in claim 3, wherein the first receiver-transmitter end is a secure digital input/output interface.

5. The video transmission device as in claim 3, wherein the second receiver-transmitter end is an infrared signal receiver-transmitter interface for providing a receiving channel to receive a control signal to the processing unit from a remote controller; the control signal utilized to assist the video transmission device and further increase the functionality of the video transmission device.

6. The video transmission device as in claim 1, wherein the input/output card connected to the first receiver-transmitter end of the receiver-transmitter unit through a cable.

7. The video transmission device as in claim 1, wherein the memory unit comprises a first memory, a second memory and a third memory; and
the first memory is a flash memory, the second memory is a frame memory and the third memory is a synchronous dynamic random access memory (SDRAM).

8. The video transmission device as in claim 7, wherein the memory unit further comprises a fourth memory that is an external memory.

9. The video transmission device as in claim 1, wherein the processing unit comprises a processor and an operator, and the processing unit is a DSP digital image engine.

10. The video transmission device as in claim 1, wherein the terminal output unit comprises a first output end and a second output end; and
the first output end is a video encoder or an S-video encoder and the second output end is a VGA de-interlacer.

11. A video transmission method, comprising the steps of:
installing an input/output card of a video transmission device to a portable device;
receiving a data signal stored in the portable device for further transmitting the data signal to a processing unit through the input/output card that connects to a receiver-transmitter unit of the video transmission device according to a system data stored in a memory unit of the video transmission device;
processing the data signal for further transmitting to a terminal output unit according to the system data; and
outputting the data signals.

12. The video transmission method as in claim 11, wherein the portable device is a personal digital assistant (PDA) or a portable phone.

13. The video transmission method as in claim 11, wherein a first receiver-transmitter end in the receiver-transmitter unit for receiving the data signal through the input/output card and a second receiver-transmitter end in the receiver-transmitter unit for providing a receiving channel to receive a control signal from a remote control unit outside the video transmission device; wherein the control signal for assisting the video transmission device and increasing the functionality of the video transmission device.

14. The video transmission method as in claim 11, wherein the input/output card is a secure input/output card that is connected to the receiver-transmitter unit through a cable.

15. The video transmission method as in claim 11, wherein a first memory in the memory unit for storing the system data for the processing unit, a second memory in the memory unit for storing an operation messages of the data signal processed by the processing unit and a third memory in the memory unit for temporarily storing an operation messages of the data signal processed by the processing unit.

16. The video transmission method as in claim 11, wherein the processing unit is a DSP digital image engine.

17. The video transmission method as in claim 11, wherein as a first output end in the terminal output unit operates, a second output end in the terminal output unit doesn't; and vice versa.

18. The video transmission method as in claim 17, wherein the first output end is an encoder for encoding the data signals as a video signal or an S-video signal.

19. The video transmission method as in claim 17, wherein the second output end is a de-interlacer for reassembling the data signal as a VGA signal.

20. The video transmission method as in claim 11, wherein the video transmission device further comprises a fourth memory that is an external memory.
